(19) United States
(12) Patent Application Publication
(10) Pub. No.: US 2009/0046206 A1
(43) Pub. Date: Feb. 19, 2009

(54) VIDEO PROCESSING APPARATUS AND VIDEO PROCESSING METHOD

(75) Inventor: Hirotoshi Miyazawa, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/190,201

(22) Filed: Aug. 12, 2008

(30) Foreign Application Priority Data
Aug. 13, 2007 (JP) 2007-210974

(51) Int. Cl. H04N 9/64

(52) U.S. Cl. 348/649; 348/E09.037

(57) ABSTRACT

According to one embodiment, a hue signal and an actually measured saturation value are generated based on received first and second color signals and a saturation maximum value is generated based on a hue signal and received luminance signal. The first and second color signals are subjected to a correction process when the actually measured saturation value exceeds the saturation maximum value and the luminance signal and the first and second color signals that are subjected to the correction process are converted into R, G and B signals.

### CROSS-REFERENCE TO RELATED APPLICATIONS

This application is based upon and claims the benefit of priority from Japanese Patent Application No. 2007-210974, filed Aug. 13, 2007, the entire contents of which are incorporated herein by reference.

### BACKGROUND

1. Field

One embodiment of the invention relates to a video processing apparatus and a video processing method for executing a color conversion process on a video signal that requires an output device without changing hues.

2. Description of the Related Art

As a result of the advancement of digital video technologies in recent years, the scope of video signals that can be displayed on a display screen has been and still is expanding. Thus, given video signals are more often than not subjected to conversion processes before they are displayed on a display screen.

Jpn. Pat. Appln. Publication No. 2007-074063 discloses a technique of computationally determining a saturation and a hue of each pixel of an input image and then a saturation distribution and the maximal value or modal value of saturation of the image and also determining a correction value to be used for making corrections in order to improve the saturation of a low saturation region.

However, with the technique described in Jpn. Pat. Appln. Publication No. 2007-074063, the hue is changed as the saturation of an image signal is corrected. Then, the video to be displayed on a television set, for example, may be changed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram of a television receiving set, which is an embodiment of the present invention;

FIG. 2 is a schematic block diagram of a video signal processing section of the television receiving set of the first embodiment;

FIG. 3 is a schematic block diagram for explaining a signal correction section of the video signal processing section of the television receiving set of the first embodiment;

FIG. 4 is a schematic illustration for explaining an operation of the signal correction section of the video signal processing section of the television receiving set of the first embodiment;

FIG. 5 is a schematic illustration of the relationship of luminance, hue and saturation at the signal correction section of the first embodiment; and

FIG. 6 is a schematic block diagram of another signal correction section of the video signal processing section of the first embodiment.

### DETAILED DESCRIPTION

Various embodiments according to the invention will be described hereinafter with reference to the accompanying drawings. In general, according to one embodiment of the invention, a hue signal and an actually measured saturation value are generated based on received first and second color signals and a saturation maximum value is generated based on a hue signal and received luminance signal. The first and second color signals are subjected to a correction process when the actually measured saturation value exceeds the saturation maximum value and the luminance signal and the first and second color signals that are subjected to the correction process are converted into R, G and B signals.

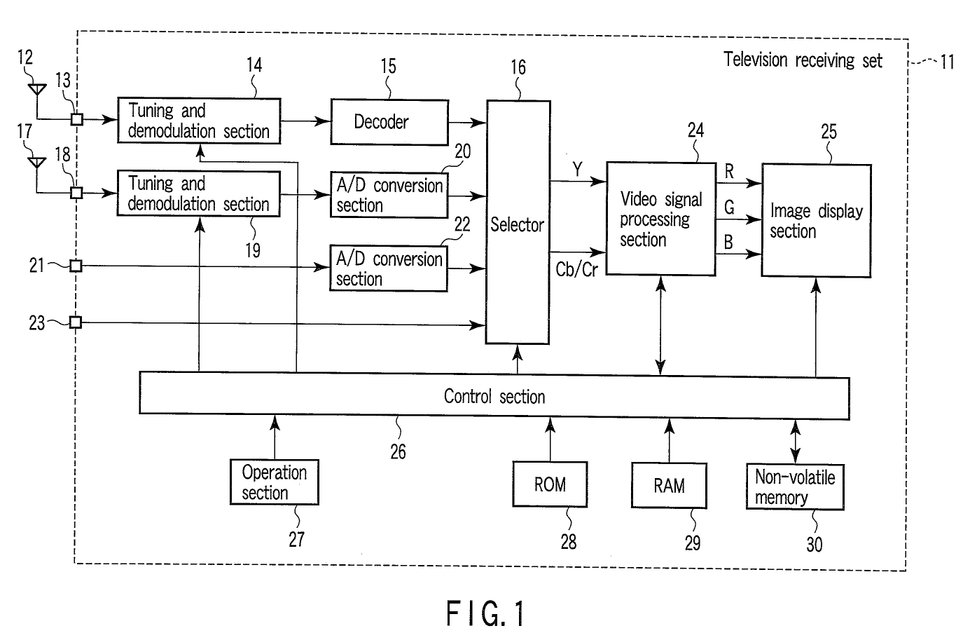

Now, a preferred embodiment of the present invention will be described in greater detail by referring to the accompanying drawing. FIG. 1 is a schematic block diagram of a television receiving set 11, which is an embodiment of the present invention, illustrating a video signal processing system thereof. Digital television broadcast signals received by way of an antenna 12 for receiving digital television broadcast signals are supplied to a tuning and demodulation section 14 by way of an input terminal 13.

The tuning and demodulation section 14 selects the broadcast signal of a desired channel out of the input digital television broadcast signals and modulates the selected signal and outputs the signal to a decoder 15. Then, the decoder 15 executes a decoding process on the signal input from the tuning and demodulation section 14 to generate a luminance signal Y and color signals Cb/Cr that are digital signals and outputs the generated signals to a selector 16.

Analog television broadcast signals received by way of an antenna 17 for receiving analog television broadcasting signals are supplied to a tuning and demodulation section 19 by way of an input terminal 18. The tuning and demodulation section 19 selects the broadcast signal of a desired channel out of the input analog television broadcast signals and modulates the selected signal to generate a luminance signal Y and color signals Cb/Cr that are analog signals.

The analog luminance signal Y and the color signals Cb/Cr generated by the tuning and demodulation section 19 are then supplied to an analog/digital (AD) conversion section 20 and converted into a digital luminance signal Y and digital color signals Cb/Cr before they are output to the selector 16.

On the other hand, the analog luminance signal Y and the color signals Cb/Cr supplied to an external input terminal 21 for analog video signals and converted into a digital luminance signal Y and digital color signals Cb/Cr by A/D conversion section 22 before they are output to the selector 16. The digital luminance signal Y and the digital color signals Cb/Cr supplied to the external input terminal 23 for digital video signals are supplied straight to the selector 16.

The selector 16 selects a set of a digital luminance signal Y and digital color signals Cb/Cr out of the sets of signals supplied from the decoder 15, the A/D conversion sections 20, 22 and the external input terminal 23 and supplies it to a video signal processing section 24.

The video signal processing section 24 executes a predetermined signal process on the digital luminance signal Y and the digital color signals Cb/Cr input thereto in order to generate R (red), G (green) and B (blue) signals as will be described in greater detail hereinafter.

The R, G and B signals generated by the video signal processing section 24 are then supplied to a video display section 25, which displays an image corresponding to the input signals. A flat panel display such as a surface-conduction electron-emitter display, a liquid crystal display or a plasma display is typically employed for the video display section 25.

The television receiving set 11 is comprehensively controlled by a control section 26 for its various operations including operations of receiving signals. The control section 26 is a microprocessor containing a CPU (central processing unit) and controls the components of the television receiving set 11 in response to the operation information it receives from an operation section 27 that includes a remote controller (not shown) so as to reflect the operations contained in the operation information.

The control section 26 makes use of a ROM (read only memory) 28 storing the control program that the CPU executes, a RAM (random access memory) 29 for providing the CPU with operation areas and a non-volatile memory 30 storing information on various defined values and control information.

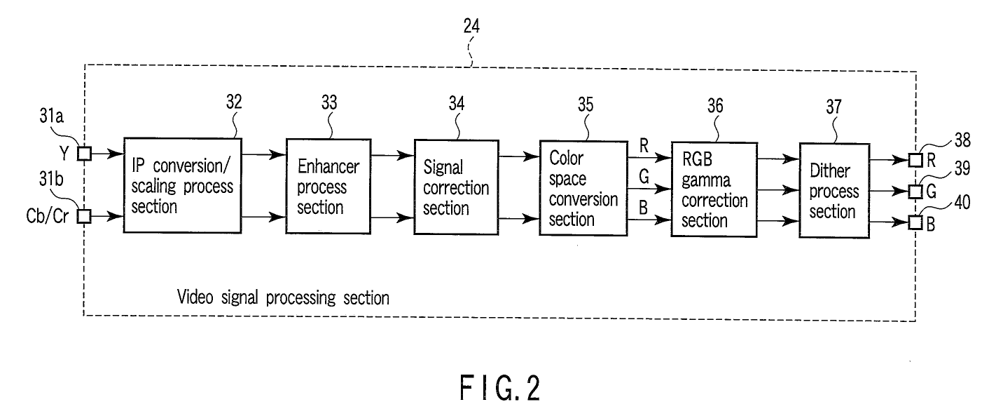

FIG. 2 is a schematic block diagram of the video signal processing section 24. Referring to FIG. 2, the digital luminance signal Y and the digital color signals Cb/Cr selected by the selector 16 are then supplied to an IP (interlace progressive) conversion/scaling process section 32 by way of input terminals 31a, 31b.

The IP conversion/scaling process section 32 executes a progressive conversion process and a scaling process for displaying an image on the video display section 25 (realized by using a flat panel display, which may be a surface-conduction electron-emitter display, a liquid crystal display or a plasma display) on the luminance signal Y and the color signals Cb/Cr input thereto and outputs them to an enhancer process section 33.

The enhancer process section 33 executes an enhancer process for making the rising edges of the luminance signal Y and the color signals Cb/Cr input thereto sharp both vertically and horizontally or changing the degree of sharpness and outputs the signals to a signal correction section 34.

The signal correction section 34 executes a contour correction process on the input luminance signal Y, which is followed by an amplitude control process on the color signals Cb/Cr, and outputs the signals to a color space conversion section 35.

The color space conversion section 35 converts the luminance signal Y and the color signals Cb/Cr input thereto into R, G and B signals and outputs them to an RGB gamma correction section 36. The RGB gamma correction section 36 executes a white balance adjustment on the R, G and B signals input thereto and a gamma correction process for the video display section 25 before it outputs the signals to a dither process section 37.

The dither process section 37 executes a compression process on the input R, G and B signals to convert the high tone bit expression realized by expanding the number of bits of the signals in order to enhance the expression into the number of bits good for a low tone bit expression and subsequently outputs the signals to the video display section 25 by way of output terminals 38, 39 and 40.

The signal correction section 34 computationally determines the saturation maximum value (A) according to the hue signal and the luminance signal Y and executes a necessary correction process within the range defined by the saturation maximum value (A) for the purpose of converting the luminance signal Y and the color signal Cb/Cr input thereto into signals that can be displayed on the video display section 25 that is the output device of the apparatus as will be described in greater detail hereinafter.

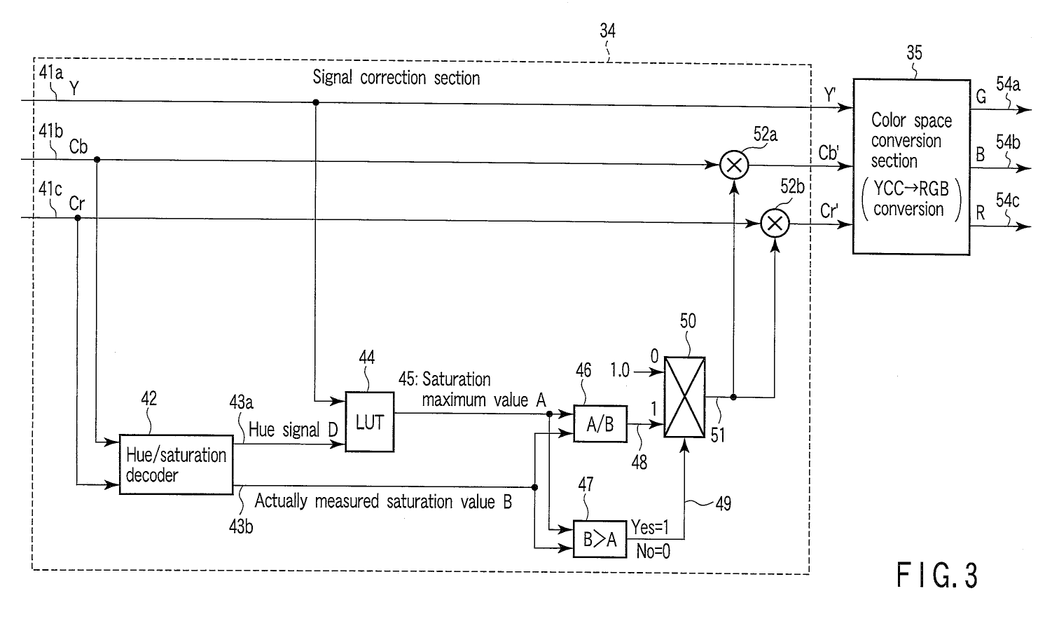

More specifically, the luminance signal Y, the color signal Cb and the color signal Cr are input to the signal correction section 34 by way of signal lines 41a, 41b, 41c respectively as shown in FIG. 3. Of the signals, the color signals Cb and Cr are supplied to a hue/saturation detector 42. The hue/saturation decoder 42 generates a hue signal D and an actually measured saturation value B according to the color signals Cb and Cr input thereto.

The hue signal D is supplied to an LUT (look-up table) 44 by way of a signal line 43a along with the luminance signal Y supplied to the signal line 41a. The LUT 44 generates a saturation maximum value A according to the luminance signal Y and the hue signal D input thereto and outputs them to an arithmetic section 46 and a comparator 47 by way of a signal line 45. The actually measured saturation value B generated by the hue/saturation decoder 42 is also supplied to the arithmetic section 46 and the comparator 47 by way of a signal line 43b.

The outcome of the arithmetic operation of the arithmetic section 46 and the outcome of the comparison of the comparator 47 are supplied to a selector 50 respectively by way of signal lines 48 and 49. The selector 50 operates so as to selectively output the outcome of the arithmetic operation of the arithmetic section 46 or a predefined reference value “1.0” according to the outcome of the comparison of the comparator 47.

The signal selected by the selector 50 is then supplied to multipliers 52a, 52b by way of a signal line 51. Of the multipliers, the multiplier 52a multiplies the output signal of the selector 50 and the color signal Cb supplied to the signal line 41b and then outputs the product of the multiplication to the color space conversion section 35 as color signal Cb′.

The multiplier 52b multiplies the output signal of the selector 50 and the color signal Cr supplied to the signal line 41a and outputs the product of the multiplication to the color space conversion section 35 as color signal Cr′. The luminance signal Y supplied to the signal line 41a is supplied straight to the color space conversion section 35 as luminance signal Y′.

Now, the operation of the signal correction section 34 for executing a signal correction process will be described below. As described above, the hue/saturation decoder 42 generates a hue signal D and an actually measured saturation value B according to the color signals Cr and Cb input thereto and outputs them. Subsequently, a saturation maximum value A is obtained as the luminance signal Y and the hue signal D are input to the LUT 44. The LUT 44 stores data of a matrix where luminance signals Y and hue signals D are arranged as addresses and the data indicates the saturation maximum values A of combinations of luminance signals Y and hue signals D.

The saturation maximum value A and the actually measured saturation value B are supplied to the arithmetic section 46 and an arithmetic operation is conducted for the saturation maximum value A/the actually measured saturation value B to generate a saturation correction output. At the same time, the comparator 47 determines whether the actually measured saturation value B exceeds the saturation maximum value

A (A>B) or not. The comparator 47 outputs “1” when the former exceeds the latter, whereas it outputs “0” when the former does not exceed the latter, to the selector circuit 50 as selector control signal.

The selector circuit 50 selects a value, using the selector control signal. More specifically, selector circuit 50 selects the reference value “1.0” when the actually measured saturation value B is not greater than the saturation maximum value A but it selects the saturation correction value from the arithmetic section 46 when the actually measured saturation value B is greater than the saturation maximum value A.

Thereafter, the multipliers 52a, 52b operate for multiplications using the output of the selector 50. More specifically, the dynamic range is limited for the color signals Cb and Cr in correspondence to the saturation maximum value A when the actually measured saturation value B exceeds the saturation maximum value A, whereas no correction process is executed when the actually measured saturation value B is not greater than the saturation maximum value A.

Thus, G, B and R signals are obtained as the luminance signal Y′ and the color signals Cb′, Cr′ obtained from the signal correction section 34 in a manner as described above are supplied to the color space conversion section 35 and subjected to a YCC/RGB conversion. The obtained G, B and R signals are then output to the RGB gamma correction section 36 by way of signal lines 54a, 54b, 54c respectively.

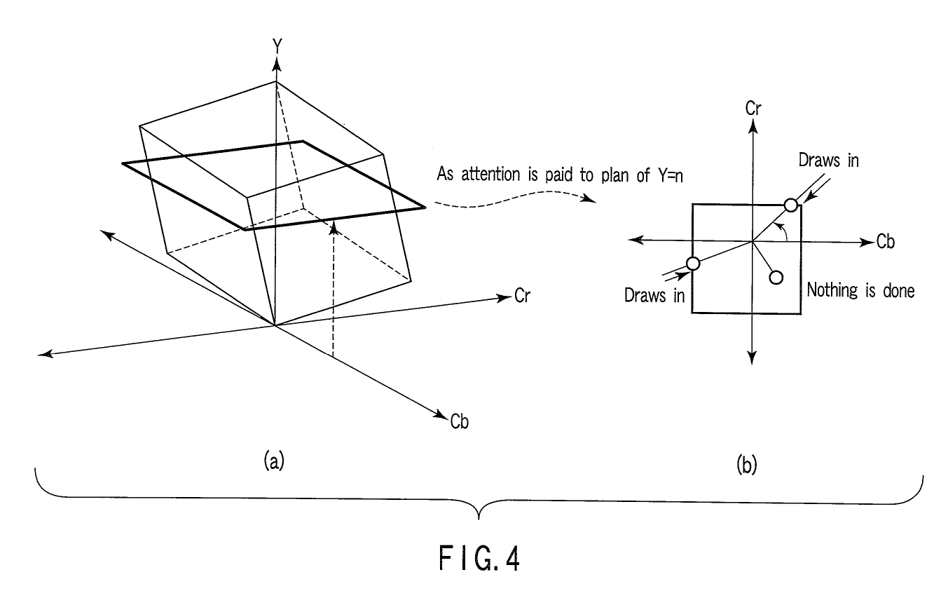

FIG. 4 is a schematic illustration for explaining an operation of the signal correction section 34. In (a) of FIG. 4, Y, Cb and Cr are arranged on the three axes that are orthogonal relative to each other and the rectangular parallelepiped drawn there refers to the saturation maximum value given by the LUT 44. In (b) of FIG. 4, the plane where Y=n is selected and illustrated. The square drawn in (b) indicates the saturation maximum value A that is obtained when the square is Y=n. No correction process is particularly executed when the input video signal is found in the frame of the saturation maximum value A, whereas a correcting operation is conducted so as to draw the input video signal into the frame of the saturation maximum value A when it is out of the frame of the saturation maximum value A. Any change in the hue is prevented from taking place at this time since the same multiplication process is executed on the color signals Cb and Cr.

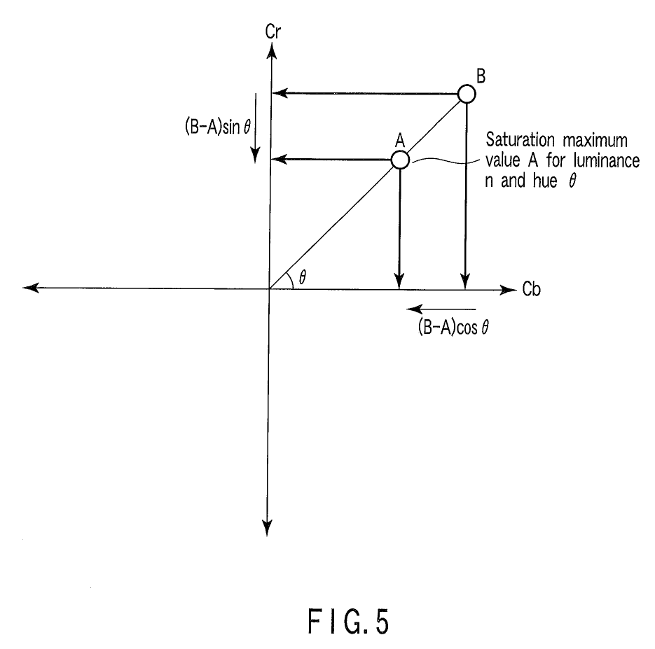

FIG. 5 is a schematic illustration of the relationship of luminance, hue and saturation at the signal correction section 34. From FIG. 5, it can be seen that the correction value of the color signal Cr is (B−A) sin θ and the correction value of the color signal Cb is (B−A) cos θ when the actually measured saturation value B of the input video signal exceeds the defined saturation maximum value A.

Thus, with the above-described embodiment, since the limit of the output dynamic range of color is subjected to a correction process so that no change takes place in the hue. Thus, as a result, a signal that cannot be normally displayed can be displayed without giving any feeling of displeasure due to a color change to the viewer.

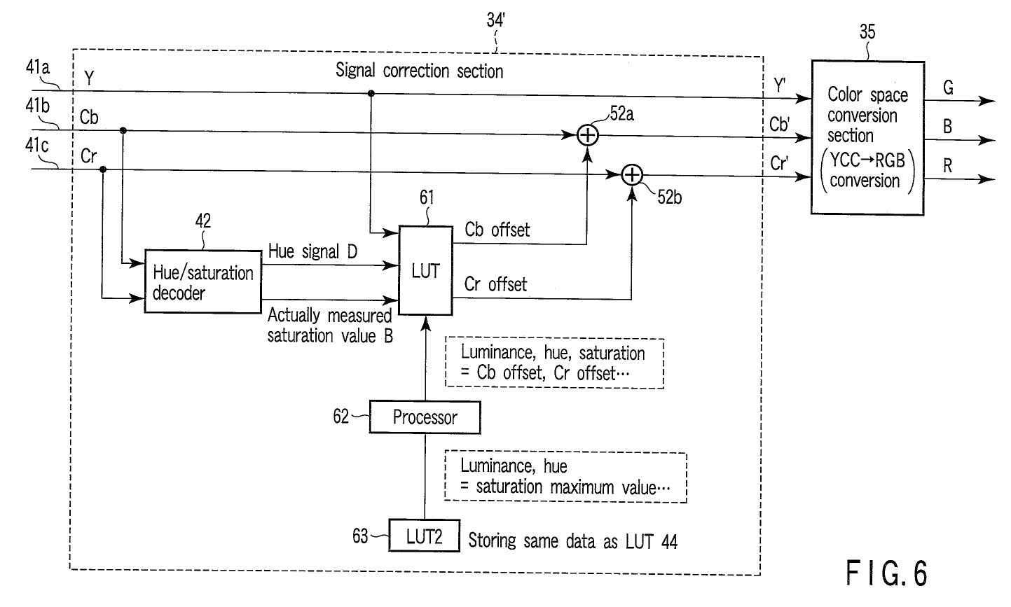

FIG. 6 is a schematic block diagram another signal correction section 34 adapted to execute a correction process by means of a processor 62. In other words, the signal correction section 34 is equivalent to the signal correction section 34 of the above-described embodiment because the processor 62 and the control program thereof are made to have the functional features of the arithmetic section 46, the comparator 47, the selector circuit 50 and so on illustrated in FIG. 3 for process executions. In FIG. 6, an LUT 61 storing correction values of color signals Cb and those of color signals Cr that correspond to luminance signals Y, hue signals D and actually measured saturation values B is provided in addition to an LUT 63 that is equivalent to the LUT 44. The data stored in the LUT 61 are provided by advance arithmetic operations so that neither an arithmetic process nor a comparison process is required for each input video signal and the overall process can be executed very quickly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing apparatus comprising:
a hue/saturation generating section arranged to receive a luminance signal and first and second color signals and generate a hue signal and an actually measured saturation value based on the first and second color signals;
a saturation maximum value generating section arranged to generate a saturation maximum value based on the hue signal generated by the hue/saturation generating section and the luminance signal;
correction sections arranged to execute a correction process on the first and second color signals when the actually measured saturation value exceeds the saturation maximum value; and
a conversion section arranged to convert the luminance signal and the first and second color signals subjected to the correction process by the correction sections into R, G and B signals.

2. The apparatus according to claim 1, wherein
the first and second color signals are a Cb signal and a Cr signal.

3. The apparatus according to claim 1, wherein
the correction sections are arranged to execute a correction process on the first and second color signals based on a ratio of the actually measured saturation value and the saturation maximum value.

4. The apparatus according to claim 1, wherein
the saturation maximum value generating section is arranged to obtain the saturation maximum value from a LUT where luminance signals and hue signals are arranged as addresses.

5. The apparatus according to claim 1, wherein
the correction sections are arranged to output straight the first and second color signals without correction when the actually measured saturation value is not greater than the saturation maximum value; and
the conversion section is arranged to convert the luminance signal and the first and second color signals that are not subjected to a correction process at the correction sections into R, G and B signals.

6. A video processing apparatus comprising:
a hue/saturation generating section arranged to receive a luminance signal and first and second color signals and generate a hue signal and an actually measured saturation value based on the first and second color signals;
a first LUT arranged to obtain a saturation maximum value using the hue signal generated by the hue/saturation generation section and the luminance signal as addresses;
a second LUT arranged to generate offsets for correction relative to the first and second color signals respectively based on the luminance signal, the hue signal and the actually measured saturation value when the actually measured saturation value exceeds the saturation maximum value;
correction sections arranged to execute a correction process on the first and second color signals based on the offsets generated by the second LUT; and
a conversion section arranged to convert the luminance signal and the first and second color signals subjected to the correction process by the correction sections into R, G and B signals.

7. A video processing method comprising:
receiving a luminance signal and first and second color signals;
generating a hue signal and an actually measured saturation value based on the first and second color signals;
generating a saturation maximum value based on the generated hue signal and the luminance signal;
executing a correction process on the first and second color signals when the actually measured saturation value exceeds the saturation maximum value; and
converting the luminance signal and the first and second color signals subjected to the correction process into R, G and B signals.

8. The method according to claim 7, wherein
said executing a correction process is executing a correction process on the first and second color signals based on a ratio of the actually measured saturation value and the saturation maximum value.

9. The method according to claim 7, wherein
said executing a correction process is outputting straight the first and second color signals without correction when the actually measured saturation value is not greater than the saturation maximum value; and
said converting is converting the luminance signal and the first and second color signals that are not subjected to a correction process into R, G and B signals.
